(19) United States
(12) Patent Application Publication
(10) Pub. No.: US 2005/0132777 A1
(43) Pub. Date: Jun. 23, 2005

(54) Method of detecting and/or monitoring an increase in atmospheric radioactivity due to purposeful dispersion of radioactive material, such as in a terrorist attack

(76) Inventor: Derek R. Lane-Smith, Billerica, MA (US)

Correspondence Address: Law Office - Dinesh Agarwal, P.C., Suite 330, 5350 Shawnee Road, Alexandria, VA, 22312, US

(21) Appl. No.: 10/742,825

(22) Filed: Dec. 23, 2003

(51) Int. Cl. G01N 25/18

(52) U.S. Cl. 73/25.03

(57) ABSTRACT

A method of detecting and/or monitoring an increase in atmospheric radioactivity caused by purposeful (or accidental) dispersion of radioactive material, such as in an act of terrorism, by using a radiological dispersion device (RDD) or “dirty bomb”, includes measuring the conductivity of air, or the concentration of fast ions therein, before, during, and/or after a suspected RDD event and comparing the measured values to determine timing, intensity, location, flow direction, boundaries, etc., of a radioactive plume.

### BACKGROUND OF THE INVENTION

The present invention is generally directed to detecting and/or monitoring atmospheric radioactivity, and more particularly to a method of detecting and/or monitoring atmospheric radioactivity caused by purposeful dispersion of a radioactive material, such as in an act of terrorism.

The unexpected and unbelievable terrorist attack of Sep. 11, 2001, that demolished the twin towers in New York and severely damaged one of the five wings of the Pentagon in the Washington, D.C. metropolitan area, brought to the forefront many national security-related issues. Although the security of the country and well being of its citizens have always received significant attention by the U.S. Government, the level of attention in the post-September 11 years, quite obviously reached to a new level. A new Federal agency, the Department of Homeland Security was created within a short period thereafter, which now commands the same authority as any other Federal agency.

Although in the September 11^{th} attack, terrorist used commercial jetliners to take nearly 3,000 lives and cause monumental damage to the real property, the present concern revolves around high probability of yet another terrorist attack that might involve purposeful dispersion of radioactive material through the use of a “dirty bomb” or some other radiological dispersal device (RDD). A dirty bomb would include radioactive material packed with, or around, a standard high explosive device. Upon explosion, the radioactive material will be dispersed over a wide area and a portion will rise up in a cloud above the explosion site. This cloud will then drift downwind with the heavier particles precipitating out quickly and finer particles staying aloft in the air longer. When the dust has fallen out of the cloud, it will become an invisible cloud, or plume, stretching downwind for miles from the explosion site. Detonation of such dirty bomb could obviously result in heavy damage to property and take thousands of lives, not to mention the health hazard the radiation would create for many thousands more lives.

In an effort to deal with potential uncertainties of this type, although contingency plans have been developed and are available to the general public, many weaknesses remain, however, including one relating to the lack of radiation measurement devices to characterize the type, extent and amount (activity) of radiation resulting from an RDD, particularly during the first few critical hours immediately following the dispersal. (See Burkhart, James F., “A Proposal to Set Up a Network of MRST Measurement Professionals to Act as First Responders in the Event of an Accidental Purposeful Radioisotope Event, MRST 2003 International Radon Symposium, Nashville, Tenn., Oct. 5-8, 2003).

Burkhart in his proposal suggests the use of existing Radon measurement equipment to monitor or measure the increase in background radiation caused by air-borne radioactive particles. He provides a list of many radioisotopes that could be used in a radiological attack of this type, and assesses the effectiveness of various radon monitoring devices and applicability of some to detect a specific type of radiation, but concludes by recommending a Geiger counter.

Conventional radon measurement devices, however, may not be very effective in accurately determining the extent and effect of such an event for the following reasons. Radon gas monitors, in normal operating mode, exclude all radionuclides except radon, and so would not respond to the variety of products of a RDD event. Radon progeny monitors, on the other hand, would respond to many of the possible radioisotopes, but generally not to beta emitters.

In view of the drawbacks associated with conventional techniques and equipment, there is a need for a better and improved technique for detecting and/or monitoring an increase in atmospheric radioactivity.

### OBJECTS AND SUMMARY OF THE INVENTION

The principal object of the present invention is to provide a method of detecting and/or monitoring an increase in atmospheric radioactivity due to purposeful dispersion of radioactive material, such as in a terrorist attack.

An object of the present invention is to provide an apparatus for detecting and/or monitoring an increase in atmospheric radioactivity due to purposeful dispersion of radioactive material, such as in a terrorist attack.

Another object of the present invention is to provide an apparatus for detecting and/or monitoring an increase in atmospheric radioactivity which is capable of responding to a variety of radioactive air-borne contamination, is lightweight and portable, has a fast response time, and is inexpensive to manufacture.

Yet another object of the present invention is to provide an apparatus for detecting and/or monitoring an increase in atmospheric radioactivity which measures the effect of radiation on the air by measuring the conductivity thereof, or the concentration of fast ions therein.

An additional object of the present invention is to provide a first response method of determining the flow direction of a plume of purposefully dispersed radioactive material, such as in a terrorist attack.

Yet an additional object of the present invention is to provide a first response method of determining the intensity and/or boundary of a plume of purposefully dispersed radioactive material, such as in a terrorist attack.

In summary, the main object of the present invention is to provide a method and apparatus for detecting and/or monitoring an increase in atmospheric radioactivity due to purposeful dispersion of radioactive material, such as in a terrorist attack, which responds to a variety of radioactive air-borne contamination, is portable, responds quickly, and is inexpensive to manufacture.

At least one of the above objects is met in part by the present invention, which in one aspect includes a method of determining an increase in atmospheric radioactivity due to purposeful or accidental dispersion of radioactive material, which includes: providing an apparatus for measuring conductivity of air; exposing the apparatus to a first air sample comprising a normal level of radioactivity; measuring the conductivity of the first air sample using the apparatus; applying a predetermined ratio of proportionality to the measured conductivity of the first air sample to obtain a first value; exposing the apparatus to a second air sample suspected of comprising purposefully or accidentally dispersed radioactive material; measuring the conductivity of the second air sample using the apparatus; applying a predetermined ratio of proportionality to the measured conductivity of the second sample to obtain a second value; and comparing the first and second values; wherein an increase in the second value by a predetermined order of magnitude indicates the presence of radioactivity caused by purposeful or accidental dispersion of a radioactive material.

Another aspect of the present invention includes a method of detecting a terrorist act of dispersing radioactive material, which includes: monitoring the level of atmospheric radioactivity by measuring conductivity of air at predetermined intervals to obtain a baseline value when no terrorist activity is suspected; measuring the conductivity of a suspect air sample suspected of comprising purposefully dispersed radioactive material to obtain a second value representing the radioactivity caused by the purposefully dispersed radioactive material; and comparing the baseline value with the second value; wherein the second value being at least about two orders of magnitude higher than the baseline value indicates the presence of radioactivity caused by purposeful dispersion of a radioactive material.

Another aspect of the present invention includes a first response method of determining a flow direction of a plume of purposefully dispersed radioactive material, which includes: providing a plurality of apparatus for measuring conductivity of air; positioning the apparatus at preselected stationary locations separated by a predetermined distance; monitoring the level of atmospheric radioactivity by measuring the conductivity of air at predetermined intervals to obtain a baseline value when no purposeful dispersion of a radioactive material is suspected; and monitoring the level of atmospheric radioactivity by continuously measuring the conductivity of air when a purposeful dispersion of radioactive material is suspected; wherein one or more elevated values provided by one or more of the apparatus indicate the flow direction for a plume of purposefully dispersed radioactive material.

Another aspect of the present invention includes a first response method of determining the boundary of a plume of purposefully dispersed radioactive material, which includes: providing an apparatus for measuring conductivity of air; monitoring the level of atmospheric radioactivity by measuring the conductivity of air at predetermined intervals to obtain a baseline value when no purposeful dispersion of a radioactive material is suspected; and traversing the apparatus through a plume of purposefully dispersed radioactive material and obtaining elevated values for radioactivity during the traverse and observing transitions between the baseline value and elevated values upon ingressing and egressing the plume; wherein a transition from baseline to an elevated value on ingress and from an elevated to the baseline on egress indicate two points on the boundary of the plume.

Another aspect of the present invention includes a method of determining an increase in atmospheric radioactivity due to purposeful or accidental dispersion of radioactive material, which includes: providing an apparatus for measuring concentration of fast ions in air; exposing the apparatus to a first air sample comprising a normal level of radioactivity; measuring the concentration of fast ions in the first air sample using the apparatus; applying a predetermined ratio of proportionality to the measured concentration of fast ions in the first air sample to obtain a first value; exposing the apparatus to a second air sample suspected of comprising purposefully or accidentally dispersed radioactive material; measuring the concentration of fast ions in the second air sample using the apparatus; applying the predetermined ratio of proportionality to the measured concentration of fast ions in the second sample to obtain a second value; and comparing the first and second values; wherein an increase in the second value by a predetermined order of magnitude indicates the presence of radioactivity caused by purposeful or accidental dispersion of a radioactive material.

Another aspect of the present invention includes a method of detecting a terrorist act of dispersing radioactive material, which includes: monitoring the level of atmospheric radioactivity by measuring concentration of fast ions in air at predetermined intervals to obtain a baseline value when no terrorist activity is suspected; measuring the concentration of fast ions in a suspect air sample suspected of comprising a purposefully dispersed radioactive material to obtain a second value representing the radioactivity caused by the purposefully dispersed radioactive material; and comparing the baseline value with the second value; wherein the second value being at least about two orders of magnitude higher than the baseline value indicates the presence of radioactivity caused by purposeful dispersion of a radioactive material.

Another aspect of the present invention includes a first response method of determining a flow direction of a plume of purposefully dispersed radioactive material, which includes: providing a plurality of apparatus for measuring concentration of fast ions in air; positioning the apparatus at preselected stationary locations separated by a predetermined distance; monitoring the level of atmospheric radioactivity by measuring the concentration of fast ions in air at predetermined intervals to obtain a baseline value when no purposeful dispersion of a radioactive material is suspected; and monitoring the level of atmospheric radioactivity by continuously measuring the concentration of fast ions in air when a purposeful dispersion of radioactive material is suspected; wherein one or more elevated values provided by one or more of the apparatus indicate the flow direction for a plume of purposefully dispersed radioactive material.

Another aspect of the present invention includes a first response method of determining the boundary of a plume of purposefully dispersed radioactive material, which includes: providing an apparatus for measuring concentration of fast ions in air; monitoring the level of atmospheric radioactivity by measuring the concentration of fast ions in air at predetermined intervals to obtain a baseline value when no purposeful dispersion of a radioactive material is suspected; and traversing the apparatus through a plume of purposefully dispersed radioactive material and obtaining elevated values for radioactivity during the traverse and observing transitions between the baseline value and elevated values upon ingressing and egressing the plume; wherein a transition from baseline to an elevated value on ingress and from an elevated to the baseline on egress indicate two points on the boundary of the plume.

### BRIEF DESCRIPTION OF THE DRAWINGS

The above and other objects, novel features and advantages of the present invention will become apparent from the following detailed description of the preferred embodiment(s) of the invention, as illustrated in the drawings, in which:

FIG. 1 is a schematic illustration of the operative components of an apparatus for measuring the atmospheric radioactivity by measuring the conductivity of air (or the concentration of fast ions) according to the present invention;

FIG. 2 is a perspective view of an assembly including the components of FIG. 1;

FIG. 3 is a flowchart of a method of the present invention; and

FIG. 4 is a flowchart of an alternative method of the present invention.

### DETAILED DESCRIPTION OF THE PREFERRED EMBODIMENT(S) OF THE INVENTION

The present invention is responsive to the present concern relating to the possibility of a terrorist attack with a radiological dispersal device (RDD) or “dirty bomb”. In a dirty bomb, a conventional bomb or explosion device would be packed with and/or surrounded by radioactive material. Under these circumstances, radioactive isotopes of one or more different materials would be dispersed in a cloud around and downwind of the detonation. The air containing these radioisotopes would become heavily ionized, and thus of high conductivity. The present invention is, therefore, directed to detecting and/or monitoring atmospheric radioactivity due to purposeful (or accidental) dispersion of radioactive material, such as by a RDD or dirty bomb, quickly, unambiguously, and accurately.

The present invention utilizes the method and apparatus for measuring unattached Radon progeny disclosed in U.S. Pat. No. 6,018,985 (incorporated herein in its entirety by reference). The '985 patent discloses measuring the concentration of unattached Radon progeny in air by measuring the conductivity of the air or the concentration of fast ions, and converting the measurement to a concentration of unattached Radon progeny by applying a predetermined ratio found to exist between conductivity and the concentration of unattached Radon progeny on the one hand, or between the concentration of fast ions and unattached Radon progeny on the other hand.

The progeny of Radon are metals, such as Polonium. Fast ions are cluster molecules formed from positive atoms and negative electrons that are created due to Radon atom decays. When these charged particles do not combine with each other, they acquire water molecules to form a cluster molecule around a single charge. A cluster molecule, including a radioactive Polonium atom, is called an “unattached daughter”.

In normal fair weather, there is a vertical potential gradient outdoors at ground level of the order of 100 V/m. At around 20 km above ground the potential is typically around 200,000 V relative to the earth. This “equipotential layer” is fed by thunderstorms and discharged by a current flowing to earth through the air wherever there is a fair weather.

The air is not a perfect insulator but, because of the presence of “fast ions”, will carry an electric current in the presence of an electric field. Heavier charged particles contribute little to the conductivity of the air. Other, non-ohmic currents may also flow due, for instance, to the turbulent diffusion of charge gradients. Standard techniques exist for measuring the potential gradient, air-earth current and the conductivity of the air due both to the positive and negative fast ions.

In the upper atmosphere, air molecules are ionized mainly by cosmic rays. Closer to the ground, however, and indoors, the ionization is produced mainly by the radioactive decay of Radon (and Thoron) and their progeny.

The following are typical parameter values in the lower atmosphere. The conductivity of the outside air is typically of the order of 10⁻¹⁴ (Ωm)⁻¹. The mobility of positive fast ions is 1.4×10⁻⁴ m²/Vs. This is two to four orders of magnitude more mobile than “slow” or “attached” ions. Fast ion production rate is of the order of 10⁷ m⁻³ s⁻¹. Fast ion density in typical air is of the order of 10⁹ m⁻³. The charge on a fast ion is 1.6×10⁻¹⁹ C.

At ground level and inside buildings, in the absence of an RDD, virtually all the airborne ions are the result of the radioactive decay of Radon, Thoron and their progeny. A very small portion contain radioactive progeny and the rest are cluster molecules around negative or positives non-radioactive molecules. A Radon level of just a few Bq/m³, which is creating unattached radon daughters at the rate of around 10 m⁻³ s⁻¹ produces fast ions at a rate of 10⁷ m⁻³ s⁻¹. Therefore, for every unattached daughter created there are the order of one million fast ions produced. There is no preference between radioactive and non-radioactive molecules in terms of any attachment processes. Therefore, the ratio of fast ions to radioactive unattached progeny remains constant through all processes of equilibration, transient changes in supply of Radon and/or Thoron or changes in dust burden in the air. From the standard values quoted above, it will be appreciated that this ratio is therefore of the order of one million to one.

Similar in some ways to a photomultiplier, the charge created on the atom of a Radon daughter from the recoil of the radioactive decay is, in effect, multiplied by about one million in the ionization produced along the trail of the alpha particle created in the decay process. The total ionization rate occurring in typical ambient Radon concentrations causes a conductivity in the air which is therefore readily measurable.

It also follows from the above that the concentration of fast ions and hence the conductivity of the air indoors or outside in the lower atmosphere is an analog of the concentration of unattached progeny of Radon and its isotopes. The method of this invention relies, in part, on the principle of measuring the concentration of unattached Radon progeny in air by measuring the conductivity of the air or the concentration of fast ions.

For example, a conductivity of the order of 10⁻¹⁴ (Ωm)⁻¹ corresponds to a typical unattached progeny concentration of the order of 10 Bq/m³ so that the multiplying factor to convert conductivity of air (indoors or in the lower atmosphere) to unattached Radon progeny concentration is of the order of 10¹⁵ Bq/m³ per (Ωm)⁻¹.

Likewise, the predetermined ratio of proportionality to calculate the concentration of the unattached Radon progeny in the air based on the concentration of fast ions is approximately 10⁻⁸ Bq/m³ per m⁻³.

Therefore, the present invention utilizes the apparatus which operates on the assumption that the ionization of the air in the lower atmosphere is due entirely to Radon and its progeny. Accordingly, in the event of a purposeful dispersion of a radioactive material, such as in a terrorist attack, the apparatus being in the lower atmosphere, would determine or monitor the level of atmospheric radioactivity based on heavily ionized and, therefore, highly conductive air. As a result, by measuring the conductivity of air, or the concentration of fast ions in air, and applying a predetermined ratio of proportionality, as noted above, the apparatus would indicate the intensity or level of radioactivity caused by a “dirty bomb” or some other RDD. In other words, the calculation of Radon progeny concentration, as noted above, although is valid in the absence of an RDD, is only useful from the standpoint of providing a comparative value in the presence of an RDD. In the event of an RDD, the atmosphere would include not only the Radon progeny, but various other radioactive isotopes as well. The apparatus reading will that of unattached Radon progeny, but the actual mix of isotopes present will be different depending upon the radioactive material/contaminant used to make the RDD or dirty bomb. By obtaining a comparatively elevated or high reading from the apparatus, the presence of an RDD can be detected and/or monitored.

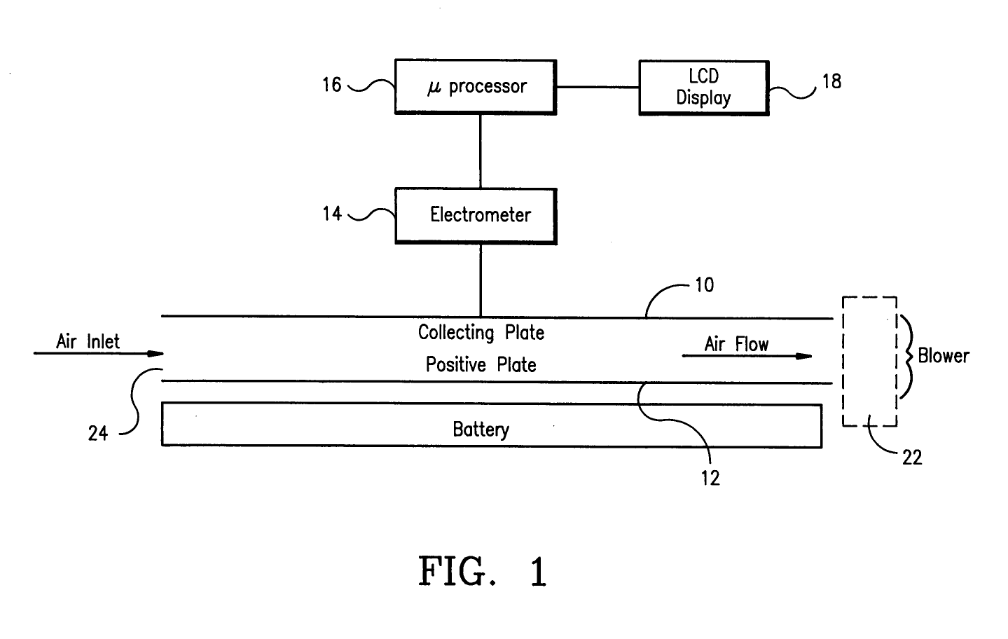

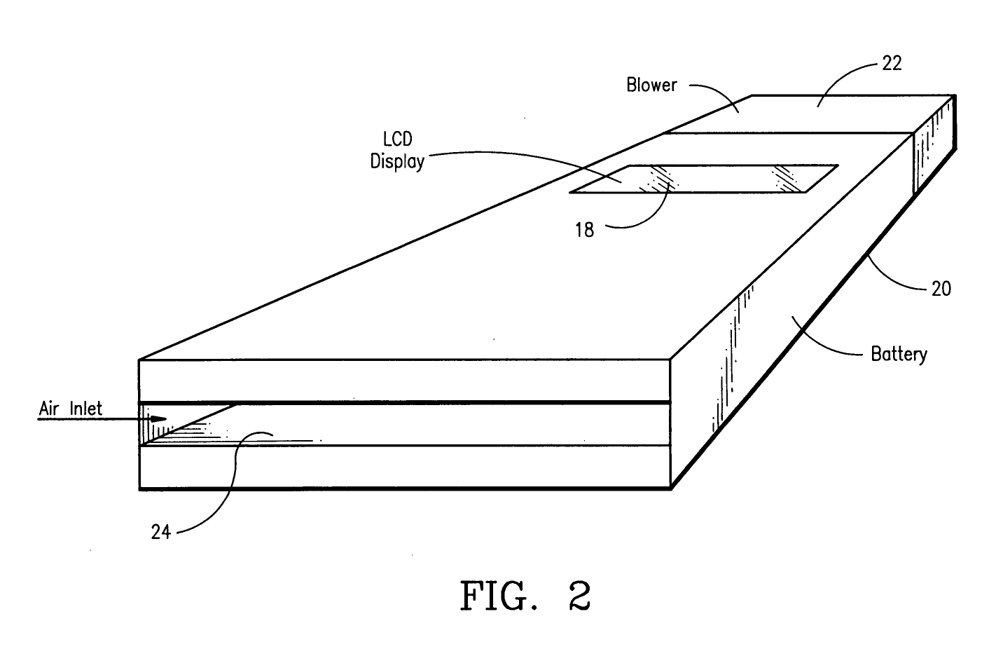

A preferred embodiment of an apparatus for measuring the conductivity is illustrated in FIGS. 1 and 2. The apparatus includes two parallel plates 10, 12 inside a grounded box 20. An air blower 22 pulls air into an air inlet 24 and through the apparatus between the plates 10, 12. One plate is held at an elevated potential (below saturation) while the other is connected to an electrometer 14 to measure the current. If V is the applied potential, d is the distance between the plates, A is the area of the plates, and I is the measured current, then the conductivity is Id/VA. The availability today of very high performance solid-state electrometer chips makes the design and manufacture of such portable apparatus feasible. Techniques known to those skilled in the art are incorporated in the circuitry associated with the condenser to reduce electrical noise and eliminate offsets. If the elevated plate potential is above saturation and the air flow rate is measured, the instrument is measuring the total fast ion concentration. If the measured current is I ampere, the flow velocity is U m³s⁻¹ and q is the charge on an ion (1.6×10⁻¹⁹ C), then the fast ion concentration, Nm⁻³, is given by N=I/qU=6.25×10¹⁸ I/U.

The current measured by electrometer 14 is indicated to microprocessor 16, which calculates the conductivity (or fast ion concentration) and performs the conversion to concentration of unattached Radon progeny, as described above. The measured concentration is outputted to an LCD display 18. A battery 21 is provided to operate the electrometer 14, microprocessor 16, and blower 22.

As noted above, in the event an RDD (or “dirty bomb”) is employed, the air in the downwind plume will be heavily ionized by the various radioactive isotopes/materials present. As a result, the reading of the apparatus upon exposure to the plume will be significantly elevated or enhanced, likely to be by several orders of magnitude, e.g., 100 times-1,000 times, or more, even though the radioactive isotopes ionizing the air and increasing its conductivity will not just be Radon progeny, but rather the radioactive materials spread by the RDD.

In normal outside air, i.e., in the absence of an RDD, the apparatus is likely to provide a reading of about between 0.03 and 1.0 pCi/L. In a plume from an RDD event, however, the reading from the apparatus is expected to be 100 pCi/L to 1,000 pCi/L, or higher. The difference between these two readings is likely to be so high that it would immediately indicate a significant increase in atmospheric radioactivity caused by air-borne radioactive particles that have likely been spread by an RDD.

The present invention proposes two techniques for detecting and/or monitoring an increase in atmospheric radiactivity due to the presence of an RDD.

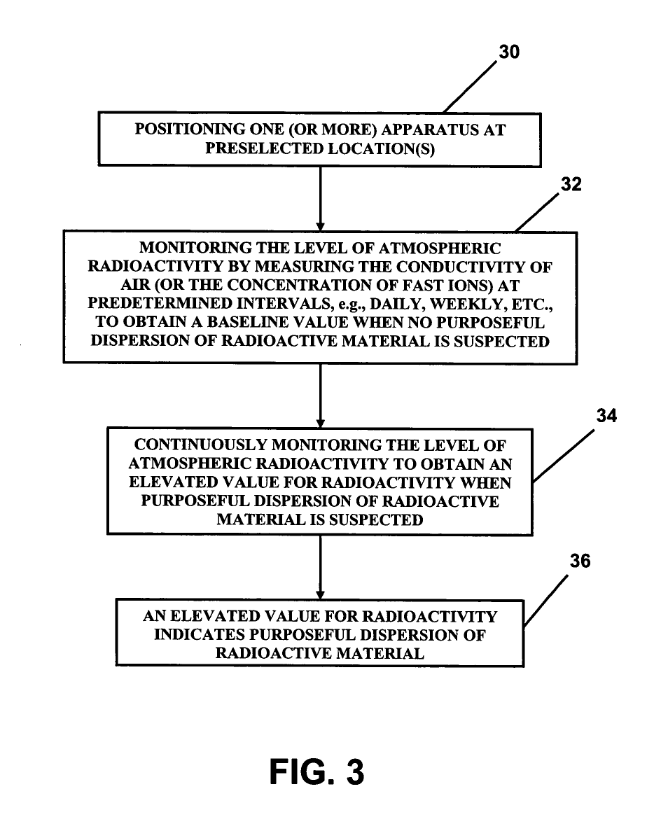

In a first method illustrated in FIG. 3, the apparatus would be positioned at a suitable stationary sampling location(s) (step 30) and measurements for the concentration of unattached Radon progeny by measuring the conductivity of air (or the concentration of fast ions), are taken periodically at predetermined intervals, such as daily, weekly or monthly. The measured values/readings would then preferably be averaged out to obtain a baseline value (step 32). In the event of an RDD incident, measurements would be carried out on a continuous basis (step 34) such that when a cloud or plume of radioactive material is exposed to or passes over the apparatus, the readings would increase significantly, likely by several orders of magnitude, thereby indicating the presence and magnitude of radiation (step 36). By positioning multiple apparatus at different strategically selected monitoring locations, the plume could be traced and its future movement predicted, and priority can be given to evacuate those in most or immediate danger.

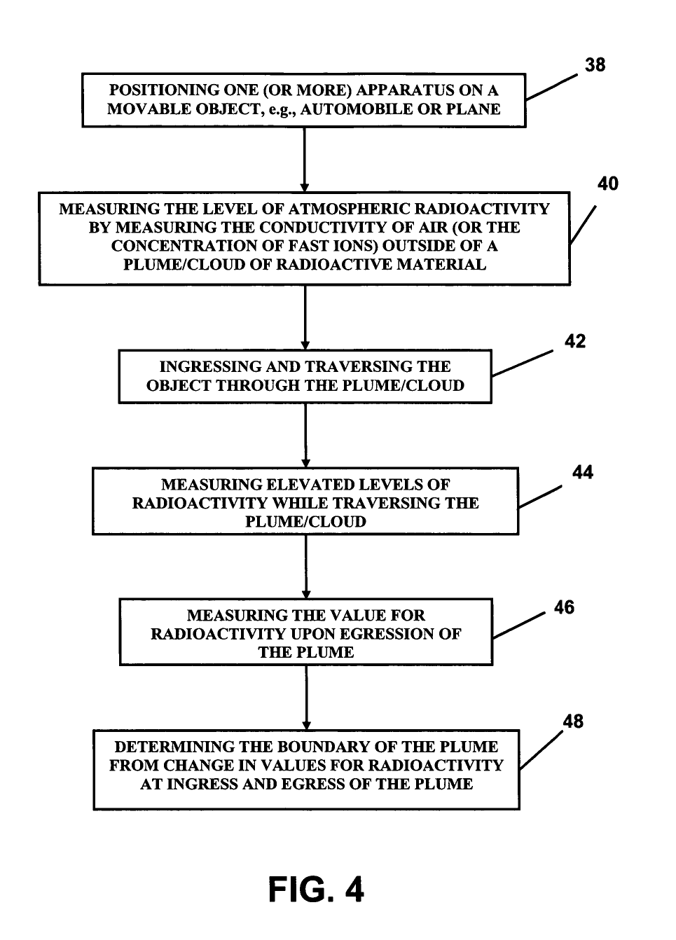

In a second method illustrated in FIG. 4, one or more apparatus would be mounted in or on a moving vehicle (step 38), such as an automobile or airplane, and the level of atmospheric radioactivity outside the plume would first be measured (step 40). The apparatus would then ingress and traverse through the plume (step 42), and elevated readings for radioactivity would be taken (step 44). Upon egression of the plume, the apparatus would take another reading for radioactivity (step 46). The change in values for radioactivity at ingress and egress would indicate two points on the boundary of the plume (step 48). In this manner, the apparatus would give normal, baseline readings outside the plume and elevated readings while traversing therethrough, and show a transition from one to the other while ingressing or egressing the plume. In this regard, it is noted that the value would likely rise upon ingression, remain high while in the plume, and fall back to baseline on egression. Based on these readings, the boundary of the plume could be determined.

From the above, one can easily observe the utility and effectiveness of the present invention. The apparatus, in view of its portability, simplicity and ease of use could be used to render fast, accurate, and reliable measurements of atmospheric radioactivity in the event an RDD (or dirty bomb) is detonated, such as in an act of terrorism.

It is noted herewith that while the present invention is described herein in terms of a purposeful dispersion of radioactive material, it can be applied to accidental dispersions as well.

While this invention has been described as having preferred sequences, ranges, steps, materials, structures, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

1. A method of determining an increase in atmospheric radioactivity due to purposeful or accidental dispersion of radioactive material, comprising the steps of:
a) providing an apparatus for measuring conductivity of air;
b) exposing the apparatus to a first air sample comprising a normal level of radioactivity;
c) measuring the conductivity of the first air sample using the apparatus;
d) applying a predetermined ratio of proportionality to the conductivity measured in step c) to obtain a first value;
e) exposing the apparatus to a second air sample suspected of comprising purposefully or accidentally dispersed radioactive material;
f) measuring the conductivity of the second air sample using the apparatus;
g) applying the predetermined ratio of proportionality to the conductivity measured in step f) to obtain a second value; and
h) comparing the first and second values;
i) wherein an increase in the second value by a predetermined order of magnitude indicates the presence of radioactivity caused by purposeful or accidental dispersion of a radioactive material.

2. The method of claim 1, wherein:
the ratio of proportionality is about 10¹⁵ Bq/m³ per (Ωm)⁻¹.

3. The method of claim 1, wherein:
the second value is at least about two orders of magnitude higher than the first value.

4. The method of claim 1, wherein:
the steps b), c) and d) are repeated at predetermined intervals to calculate a baseline value for radioactivity by averaging the first values.

5. The method of claim 1, wherein:
the step b) is carried out at a stationary location.

6. The method of claim 1, wherein:
the second air sample comprises a plume including the radioactive material; and
the step e) is carried out by traversing the apparatus through the plume.

7. The method of claim 1, wherein:
the second air sample comprises one or more of α, β, and γ radiation emitting radioactive material.

8. The method of claim 2, wherein:
the first value represents a concentration of unattached Radon progeny in the first sample.

9. The method of claim 1, wherein:
the apparatus comprises an apparatus for measuring the concentration of unattached Radon progeny in an air sample, which comprises:
i) means for measuring the conductivity of an air sample;
ii) processing means operably associated with the conductivity measuring means for calculating the concentration of the unattached Radon progeny based on a predetermined ratio of proportionality; and
iii) means for displaying the results of the processing means.

10. The method of claim 9, wherein:
the ratio of proportionality is about 10¹⁵ Bq/m³ per (Ωm)⁻¹.

11. A method of detecting a terrorist act of dispersing radioactive material, comprising the steps of:
a) monitoring the level of atmospheric radioactivity by measuring conductivity of air at predetermined intervals to obtain a baseline value when no terrorist activity is suspected;
b) measuring the conductivity of a suspect air sample suspected of comprising purposefully dispersed radioactive material to obtain a value representing the radioactivity caused by the purposefully dispersed radioactive material; and
c) comparing the baseline value with the value obtained in step b);
d) wherein the value obtained in step b) being at least about two orders of magnitude higher than the baseline value indicates the presence of radioactivity caused by purposeful dispersion of a radioactive material.

12. The method of claim 11, wherein:
the step a) comprises:
i) providing an apparatus for measuring conductivity of air;
ii) providing an air sample including attached and unattached Radon progeny;
iii) measuring the conductivity of the air sample; and
iv) applying a predetermined ratio of proportionality to the measured conductivity to obtain a value representing the concentration of the unattached Radon progeny in the air sample.

13. The method of claim 12, wherein:
the ratio of proportionality is about 10¹⁵ Bq/m³ per (Ωm)⁻¹.

14. The method of claim 11, wherein:
the value obtained in step b) is at least about three to five orders of magnitude higher than the baseline value.

15. A method of claim 11, wherein:
the step a) is carried out at a stationary location.

16. The method of claim 11, wherein:
the suspect air sample in step b) comprises a plume including the radioactive material; and
the step b) is carried out by traversing the apparatus through the plume of radiation.

17. The method of claim 11, wherein:
the suspect air sample in step b) comprises one or more of α, β, and γ radiation emitting radioactive material.

18. The method of claim 12, wherein:
the apparatus comprises an apparatus for measuring the concentration of unattached Radon progeny in an air sample, which comprises:
i) means for measuring the conductivity of an air sample;
ii) processing means operably associated with the conductivity measuring means for calculating the concentration of the unattached Radon progeny based on a predetermined ratio of proportionality; and
iii) means for displaying the results of the processing means.

19. The method of claim 18, wherein:
the ratio of proportionality is about 10¹⁵ Bq/m³ per (Ωm)⁻¹.

20. A first response method of determining a flow direction of a plume of purposefully dispersed radioactive material, the method comprising the steps of:
a) providing a plurality of apparatus for measuring conductivity of air;
b) positioning the apparatus at preselected stationary locations separated by a predetermined distance;
c) monitoring the level of atmospheric radioactivity by measuring the conductivity of air at predetermined intervals to obtain a baseline value when no purposeful dispersion of a radioactive material is suspected;
d) monitoring the level of atmospheric radioactivity by continuously measuring the conductivity of air when a purposeful dispersion of radioactive material is suspected;
e) wherein one or more elevated values provided by one or more of the apparatus in step d) indicate the flow direction for a plume of purposefully dispersed radioactive material.

21. The method of claim 20, wherein:
one of the elevated values is at least about two orders of magnitude higher than the baseline value.

22. A first response method of determining the boundary of a plume of purposefully dispersed radioactive material, the method comprising the steps of:
a) providing an apparatus for measuring conductivity of air;
b) monitoring the level of atmospheric radioactivity by measuring the conductivity of air at predetermined intervals to obtain a baseline value when no purposeful dispersion of a radioactive material is suspected; and
c) traversing the apparatus through a plume of purposefully dispersed radioactive material and obtaining elevated values for radioactivity;
d) wherein a change in values for radioactivity at ingress and egress in step c) indicates two points on the boundary of the plume.

23. The method of claim 22, wherein:
one of the elevated values is at least about two orders of magnitude higher than the baseline value.

24. A method of determining an increase in atmospheric radioactivity due to purposeful or accidental dispersion of radioactive material, comprising the steps of:
a) providing an apparatus for measuring concentration of fast ions in air;
b) exposing the apparatus to a first air sample comprising a normal level of radioactivity;
c) measuring the concentration of fast ions in the first air sample using the apparatus;
d) applying a predetermined ratio of proportionality to the concentration of fast ions measured in step c) to obtain a first value;
e) exposing the apparatus to a second air sample suspected of comprising purposefully or accidentally dispersed radioactive material;
f) measuring the concentration of fast ions in the second air sample using the apparatus;
g) applying the predetermined ratio of proportionality to the concentration of fast ions measured in step f) to obtain a second value; and
h) comparing the first and second values;
i) wherein an increase in the second value by a predetermined order of magnitude indicates the presence of radioactivity caused by purposeful or accidental dispersion of a radioactive material.

25. The method of claim 24, wherein:
the ratio of proportionality is about 10⁻⁸ Bq/m³ per m⁻³.

26. The method of claim 24, wherein:
the second value is at least about two orders of magnitude higher than the first value.

27. The method of claim 24, wherein:
the apparatus comprises an apparatus for measuring the concentration of unattached Radon progeny in an air sample, which comprises:
i) means for measuring the concentration of fast ions in an air sample;
ii) processing means operably associated with the fast ions concentration measuring means for calculating the concentration of the unattached Radon progeny based on a predetermined ratio of proportionality; and
iii) means for displaying the results of the processing means.

28. The method of claim 27, wherein:
ratio of proportionality is about 10⁻⁸ Bq/m³ per m⁻³.

29. A method of detecting a terrorist act of dispersing radioactive material, comprising the steps of:
a) monitoring the level of atmospheric radioactivity by measuring concentration of fast ions in air at predetermined intervals to obtain a baseline value when no terrorist activity is suspected;
b) measuring the concentration of fast ions in a suspect air sample suspected of comprising a purposefully dispersed radioactive material to obtain a value representing the radioactivity caused by the purposefully dispersed radioactive material; and
c) comparing the baseline value with the value obtained in step b);
d) wherein the value obtained in step b) being at least about two orders of magnitude higher than the baseline value indicates the presence of radioactivity caused by purposeful dispersion of a radioactive material.

30. The method of claim 29, wherein:
the step a) comprises:
i) providing an apparatus for measuring concentration of fast ions in air;
ii) providing an air sample including attached and unattached Radon progeny;
iii) measuring the concentration of fast ions in the air sample; and
iv) applying a predetermined ratio of proportionality to the measured concentration of fast ions to obtain a value representing the concentration of the unattached Radon progeny in the air sample.

31. The method of claim 30, wherein:
the ratio of proportionality is about 10⁻⁸ Bq/m³ per m⁻³.

32. A first response method of determining a flow direction of a plume of purposefully dispersed radioactive material, the method comprising the steps of:
a) providing a plurality of apparatus for measuring concentration of fast ions in air;
b) positioning the apparatus at preselected stationary locations separated by a predetermined distance;
c) monitoring the level of atmospheric radioactivity by measuring the concentration of fast ions in air at predetermined intervals to obtain a baseline value when no purposeful dispersion of a radioactive material is suspected;
d) monitoring the level of atmospheric radioactivity by continuously measuring the concentration of fast ions in air when a purposeful dispersion of radioactive material is suspected;
e) wherein one or more elevated values provided by one or more of the apparatus in step d) indicate the flow direction for a plume of purposefully dispersed radioactive material.

33. The method of claim 32, wherein:
one of the elevated values is at least about two orders of magnitude higher than the baseline value.

34. A first response method of determining the boundary of a plume of purposefully dispersed radioactive material, the method comprising the steps of:
a) providing an apparatus for measuring concentration of fast ions in air;
b) monitoring the level of atmospheric radioactivity by measuring the concentration of fast ions in air at predetermined intervals to obtain a baseline value when no purposeful dispersion of a radioactive material is suspected; and
c) traversing the apparatus through a plume of purposefully dispersed radioactive material and obtaining elevated values for radioactivity;
d) wherein a change in values for radioactivity at ingress and egress in step c) indicates two points on the boundary of the plume.

35. The method of claim 34, wherein:
one of the elevated values is at least about two orders of magnitude higher than the baseline value.
